(19) United States
(12) Patent Application Publication
(10) Pub. No.: US 2014/0177602 A1
(43) Pub. Date: Jun. 26, 2014

(54) UPLINK TIMING MANAGEMENT AND UPLINK POWER CONTROL

(71) Applicant: QUALCOMM INCORPORATED, San Diego, CA (US)

(72) Inventors: Wanshi Chen, San Diego, CA (US); Peter Gaal, San Diego, CA (US); Hao Xu, San Diego, CA (US)

(73) Assignee: QUALCOMM INCORPORATED, San Diego, CA (US)

(21) Appl. No.: 13/722,386

(22) Filed: Dec. 20, 2012

(51) Int. Cl. H04W 52/04; H04W 56/00

(52) U.S. Cl. CPC H04W 52/04; H04W 56/00
USPC 370/336; 370/329

(57) ABSTRACT

Certain aspects of the present disclosure relate to techniques for uplink timing management and uplink power control in wireless communications systems. A UE may detect a switch in a set of one or more transmission points (TPs) for at least one of uplink (UL) transmissions or (DL) transmissions. The uplink timing management may include the UE determining one or more DL component carriers (CCs) to use as a Timing Advance (TA) reference after the switch. The uplink power control may include a UE determining, based at least in part on one or more serving TPs after the switch, one or more power control functions to be utilized for transmission power for one or more UL channels after the switch.

The present application for patent claims priority to U.S. Provisional Application No. 61/584,051, entitled “UPLINK TIMING MANAGEMENT AND UPLINK POWER CONTROL,” filed Jan. 6, 2012, and assigned to the assignee hereof and hereby expressly incorporated by reference herein.

### BACKGROUND

1. Field

Certain aspects of the disclosure generally relate to wireless communications and, more particularly, to techniques for uplink (UL) timing management and UL power control in Long Term Evolution (LTE)-A.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

Certain aspects of the present disclosure provide a method for adjusting timing of uplink transmissions by a UE. The method generally includes performing wireless communications with uplink (UL) transmissions sent to a first set of one or more transmission points (TPs) and downlink (DL) transmissions received from a second set of one or more TPs, adjusting timing for UL transmissions based on received timing adjustment (TA) commands and timing of at least one DL component carrier (CC) used by the second set of TPs that is used by the UE as a TA reference, detecting a switch to a different set of one or more TPs for at least one of the first or second set of TPs, and determining one or more DL CCs to use as a TA reference after the switch.

Certain aspects of the present disclosure provide a method for adjusting timing of uplink transmissions by a base station. The method generally includes sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference, and sending an indication to the at least one UE of one or more DL CCs to use as a TA reference after a dynamic switch to a different set of one or more TPs for at least one of UL transmissions and downlink (DL) transmissions.

Certain aspects of the present disclosure provide a method for adjusting power of uplink transmissions by a UE. The method generally includes performing wireless communications with uplink (UL) transmissions sent to a first set of one or more transmission points (TPs) and downlink (DL) transmissions received from a second set of one or more TPs, adjusting transmission power for one or more UL channels according to one or more power control functions based on received transmission power control (TPC) commands, detecting a switch to a different set of one or more TPs for at least one of the first or second set of TPs, and determining, based at least in part on one or more serving TPs after the switch, one or more power control functions to be utilized for transmission power for one or more UL channels after the switch.

Certain aspects of the present disclosure provide a method for adjusting power of uplink transmissions by a base station. The method generally includes sending transmission power control (TPC) commands to at least one UE, wherein the at least one UE adjusts transmission power for one or more uplink (UL) channels according to one or more power control functions that are based on received TPC commands, and sending an indication to the at least one UE of one or more serving transmission points (TPs) after a dynamic switch to a different set of one or more TPs for at least one of UL transmissions and downlink (DL) transmissions, wherein the at least one UE determines, based at least in part on the one or more serving TPs after the switch, one or more power control functions to be utilized for transmission power for one or more UL channels after the switch.

Certain aspects of the present disclosure provide an apparatus for adjusting timing of uplink transmissions by a UE. The apparatus generally includes means for performing wireless communications with uplink (UL) transmissions sent to a first set of one or more transmission points (TPs) and downlink (DL) transmissions received from a second set of one or more TPs, means for adjusting timing for UL transmissions based on received timing adjustment (TA) commands and timing of at least one DL component carrier (CC) used by the second set of TPs that is used by the UE as a TA reference, means for detecting a switch to a different set of one or more TPs for at least one of the first or second set of TPs, and means for determining one or more DL CCs to use as a TA reference after the switch.

Certain aspects of the present disclosure provide an apparatus for adjusting timing of uplink transmission by a UE. The apparatus generally includes at least one processor and memory coupled to the at least one processor. The at least one processor is generally configured to perform wireless communications with uplink (UL) transmissions sent to a first set of one or more transmission points (TPs) and downlink (DL) transmissions received from a second set of one or more TPs, adjust timing for UL transmissions based on received timing adjustment (TA) commands and timing of at least one DL component carrier (CC) used by the second set of TPs that is used by the UE as a TA reference, detect a switch to a different set of one or more TPs for at least one of the first or second set of TPs, and determine one or more DL CCs to use as a TA reference after the switch.

Certain aspects of the present disclosure provide a computer program product for adjusting timing of uplink transmissions by a UE. The computer program product generally includes a computer-readable medium comprising code for performing wireless communications with uplink (UL) transmissions sent to a first set of one or more transmission points (TPs) and downlink (DL) transmissions received from a second set of one or more TPs, adjusting timing for UL transmissions based on received timing adjustment (TA) commands and timing of at least one DL component carrier (CC) used by the second set of TPs that is used by the UE as a TA reference, detecting a switch to a different set of one or more TPs for at least one of the first or second set of TPs, and determining one or more DL CCs to use as a TA reference after the switch.

Certain aspects of the present disclosure provide an apparatus for adjusting timing of uplink transmissions by a base station. The apparatus generally includes means for sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference, and means for sending an indication to the at least one UE of one or more DL CCs to use as a TA reference after a dynamic switch to a different set of one or more TPs for at least one of UL transmissions and downlink (DL) transmissions.

Certain aspects of the present disclosure provide an apparatus for adjusting timing of uplink transmissions by a base station. The apparatus generally includes at least one processor and a memory coupled to the at least one processor. The at least one processor is generally configured to send timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference, and send an indication to the at least one UE of one or more DL CCs to use as a TA reference after a dynamic switch to a different set of one or more TPs for at least one of UL transmissions and downlink (DL) transmissions.

Certain aspects of the present disclosure provide a computer program product for adjusting timing of uplink transmissions by a base station. The computer program product generally includes a computer-readable medium comprising code for sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference, and sending an indication to the at least one UE of one or more DL CCs to use as a TA reference after a dynamic switch to a different set of one or more TPs for at least one of UL transmissions and downlink (DL) transmissions.

Certain aspects of the present disclosure provide an apparatus for adjusting power of uplink transmissions by a UE. The apparatus generally includes means for performing wireless communications with uplink (UL) transmissions sent to a first set of one or more transmission points (TPs) and downlink (DL) transmissions received from a second set of one or more TPs, means for adjusting transmission power for one or more UL channels according to one or more power control functions based on received transmission power control (TPC) commands, means for detecting a switch to a different set of one or more TPs for at least one of the first or second set of TPs, and means for determining, based at least in part on one or more serving TPs after the switch, one or more power control functions to be utilized for transmission power for one or more UL channels after the switch.

Certain aspects of the present disclosure provide an apparatus for adjusting power of uplink transmissions by a UE. The apparatus generally includes at least one processor and a memory coupled to the at least one processor. The at least one processor is generally configured to perform wireless communications with uplink (UL) transmissions sent to a first set of one or more transmission points (TPs) and downlink (DL) transmissions received from a second set of one or more TPs, adjust transmission power for one or more UL channels according to one or more power control functions based on received transmission power control (TPC) commands, detect a switch to a different set of one or more TPs for at least one of the first or second set of TPs, and determine, based at least in part on one or more serving TPs after the switch, one or more power control functions to be utilized for transmission power for one or more UL channels after the switch.

Certain aspects of the present disclosure provide a computer program product for adjusting power of uplink transmissions by a UE. The computer program product generally includes a computer-readable medium comprising code for performing wireless communications with uplink (UL) transmissions sent to a first set of one or more transmission points (TPs) and downlink (DL) transmissions received from a second set of one or more TPs, adjusting transmission power for one or more UL channels according to one or more power control functions based on received transmission power control (TPC) commands, detecting a switch to a different set of one or more TPs for at least one of the first or second set of TPs, and determining, based at least in part on one or more serving TPs after the switch, one or more power control functions to be utilized for transmission power for one or more UL channels after the switch.

Certain aspects of the present disclosure provide an apparatus for adjusting power of uplink transmissions by a base station. The apparatus generally includes means for sending transmission power control (TPC) commands to at least one UE, wherein the at least one UE adjusts transmission power for one or more uplink (UL) channels according to one or more power control functions that are based on received TPC commands, and means for sending an indication to the at least one UE of one or more serving transmission points (TPs) after a dynamic switch to a different set of one or more TPs for at least one of UL transmissions and downlink (DL) transmissions, wherein the at least one UE determines, based at least in part on the one or more serving TPs after the switch, one or more power control functions to be utilized for transmission power for one or more UL channels after the switch.

Certain aspects of the present disclosure provide an apparatus for adjusting power of uplink transmissions by a base station. The apparatus generally includes at least one processor and a memory coupled to the at least one processor. The at least one processor is generally configured to send transmission power control (TPC) commands to at least one UE, wherein the at least one UE adjusts transmission power for one or more uplink (UL) channels according to one or more power control functions that are based on received TPC commands, and send an indication to the at least one UE of one or more serving transmission points (TPs) after a dynamic switch to a different set of one or more TPs for at least one of UL transmissions and downlink (DL) transmissions, and wherein the at least one UE determines, based at least in part on the one or more serving TPs after the switch, one or more power control functions to be utilized for transmission power for one or more UL channels after the switch.

Certain aspects of the present disclosure provide a computer program product for adjusting power of uplink transmissions by a base station. The computer program product includes a computer-readable medium comprising code for sending transmission power control (TPC) commands to at least one UE, wherein the at least one UE adjusts transmission power for one or more uplink (UL) channels according to one or more power control functions that are based on received TPC commands, and sending an indication to the at least one UE of one or more serving transmission points (TPs) after a dynamic switch to a different set of one or more TPs for at least one of UL transmissions and downlink (DL) transmissions, wherein the at least one UE determines, based at least in part on the one or more serving TPs after the switch, one or more power control functions to be utilized for transmission power for one or more UL channels after the switch.

Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network in accordance with certain aspects of the present disclosure.

FIG. 2A shows an example format for the uplink in Long Term Evolution (LTE) in accordance with certain aspects of the present disclosure.

FIG. 3 shows a block diagram conceptually illustrating an example of a Node B in communication with a user equipment device (UE) in a wireless communications network in accordance with certain aspects of the present disclosure.

FIG. 4 illustrates an example heterogeneous network (HetNet) in accordance with certain aspects of the present disclosure.

FIG. 5 illustrates example resource partitioning in a heterogeneous network in accordance with certain aspects of the present disclosure.

FIG. 6 illustrates example cooperative partitioning of subframes in a heterogeneous network in accordance with certain aspects of the present disclosure.

FIG. 7 illustrates UE configuration for two TA groups in accordance with certain aspects of the present disclosure.

FIG. 8 illustrates an example HetNet implementing a CoMP scheme where control and data transmission may be decoupled in accordance with certain aspects of the present disclosure.

FIG. 9 illustrates an example UL timing determination for a CoMP scheme implemented in a wireless network where control and data transmission may be decoupled in accordance with certain aspects of the present disclosure.

FIG. 10 illustrates an example of UL timing determination for a CoMP scheme implemented in a wireless network when DL and UL transmissions are switched between cells in accordance with certain aspects of the present disclosure.

FIG. 11 illustrates example timing advance (TA) signaling for uplink transmissions for two reference cells in accordance with certain aspects of the present disclosure.

FIG. 12 illustrates example operations that may be performed by a UE for adjusting timing of uplink transmissions in accordance with certain aspects of the present disclosure.

FIG. 13 illustrates example operations 1300 that may be performed by a base station for adjusting timing of uplink transmissions in accordance with certain aspects of the present disclosure.

FIG. 14 illustrates example operations that may be performed by a UE for adjusting power of uplink transmissions in accordance with certain aspects of the present disclosure.

FIG. 15 illustrates example operations 1500 that may be performed by a base station for adjusting power of uplink transmissions in accordance with certain aspects of the present disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

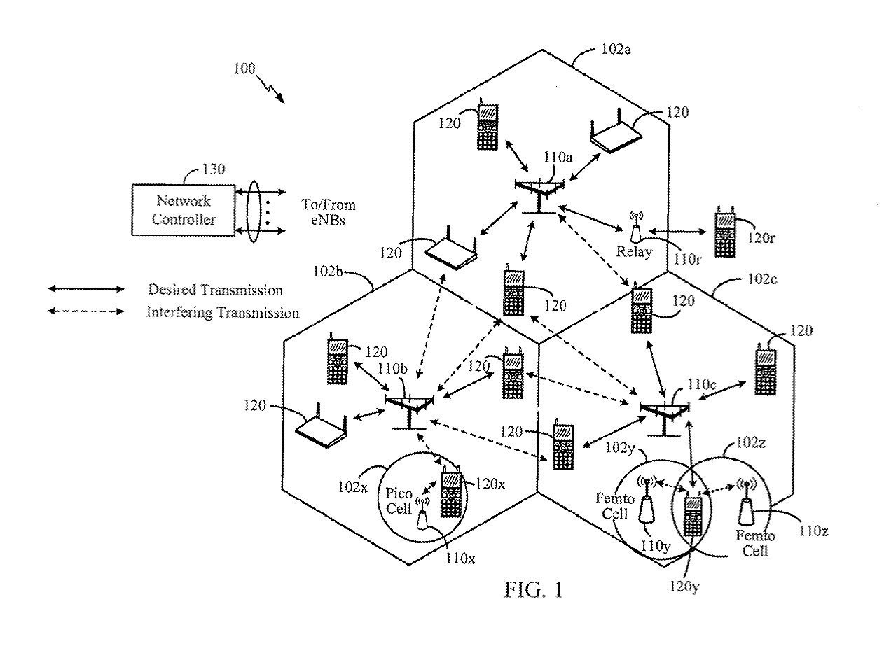

FIG. 1 shows a wireless communication network 100, which may be an LTE network. Wireless network 100 may include a number of evolved Node Bs (eNBs) 110 and other network entities. An eNB may be a station that communicates with the UEs, and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, eNBs 110a, 110b, and 110c may be macro eNBs for macro cells 102a, 102b and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

Wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

Wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in wireless network 100. For example, macro eNBs may have a high transmit power level (e.g., 20 Watts) whereas pico eNBs, femto eNBs, and relays may have a lower transmit power level (e.g., 1 Watt).

Wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. Network controller 130 may communicate with eNBs 110 via a backhaul. eNBs 110 may also communicate with one another, e.g., directly or indirectly via wireless or wireline backhaul.

UEs 120 may be dispersed throughout wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

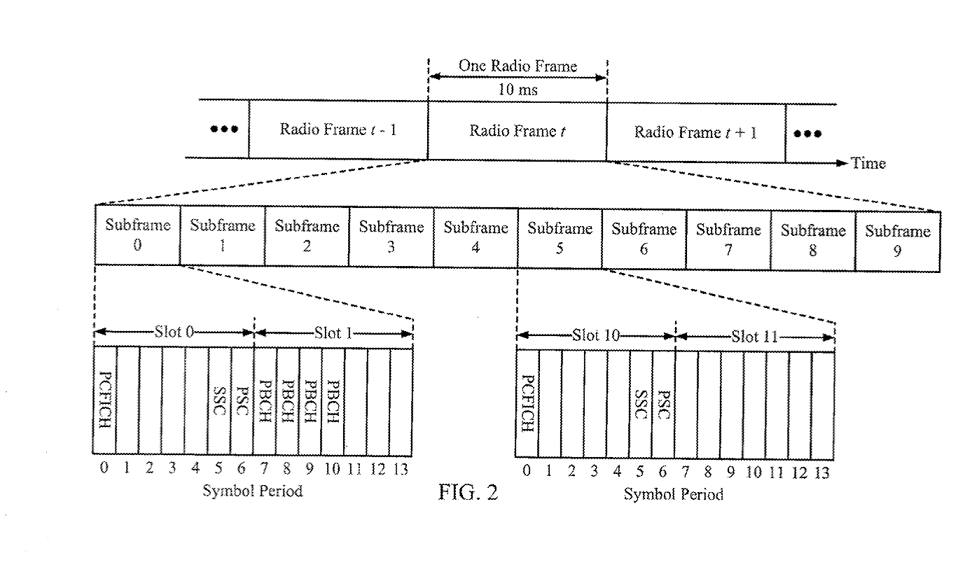

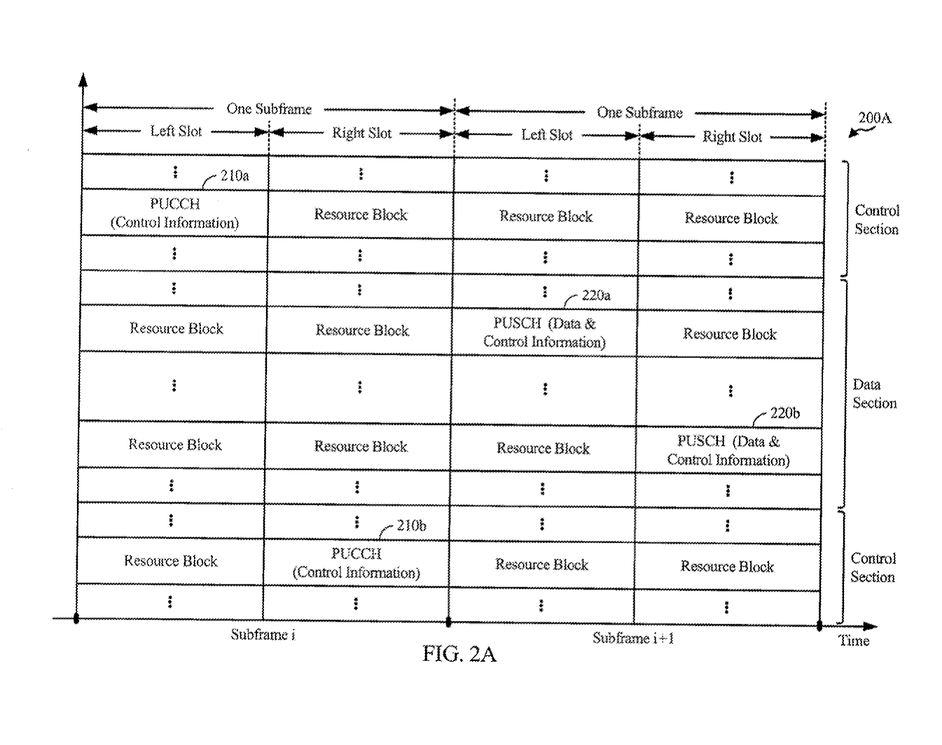

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic retransmission (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the Node B. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

The PSS, SSS, CRS, PBCH, PUCCH and PUSCH in LTE are described in 3GPP TS 36.211, entitled, “Evolved Universal Terrestrial Radio Access (E-UTRA); Physical Channels and Modulation,” which is publicly available.

A UE may be within the coverage of multiple eNBs. One of these eNBs may be selected to serve the UE. The serving eNB may be selected based on various criteria such as received power, path loss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high-received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower path loss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the path loss for eNB 110x is lower than the path loss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of the eNB at a UE (and not based on the transmit power level of the eNB).

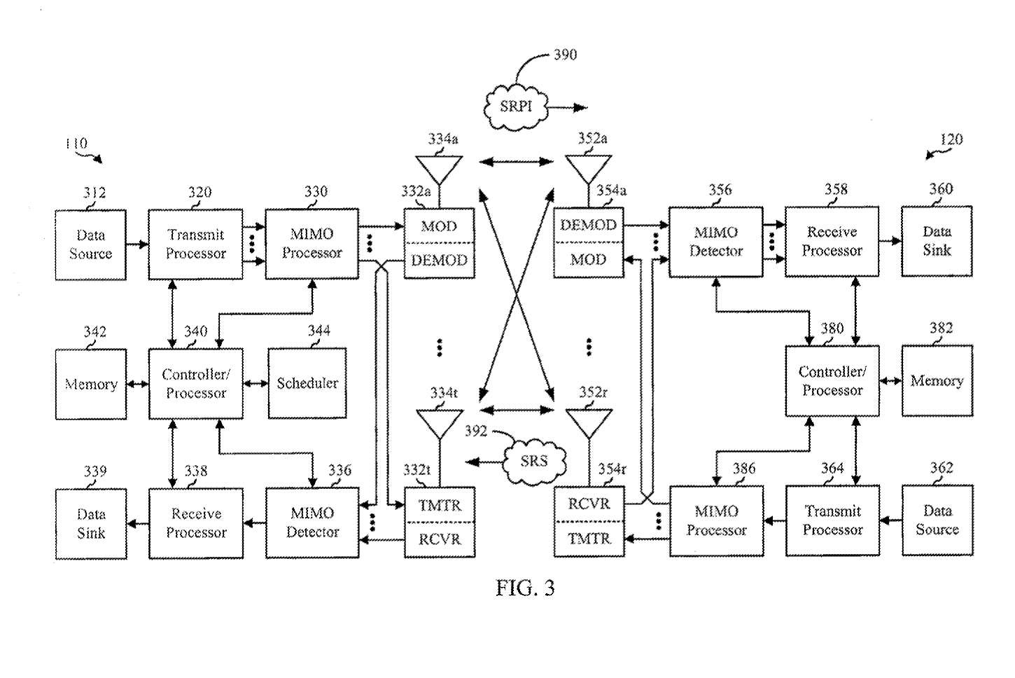

FIG. 3 shows a block diagram of a design of a base station/eNB 110 and a UE 120, which may be one of the base stations/eNBs and one of the UEs in FIG. 1. For a restricted association scenario, base station 110 may be macro eNB 110c in FIG. 1, and UE 120 may be UE 120y. Base station 110 may also be a base station of some other type. Base station 110 may be equipped with T antennas 334a through 334t, and UE 120 may be equipped with R antennas 352a through 352r, where in general T≧1 and R≧1.

At base station 110, a transmit processor 320 may receive data from a data source 312 and control information from a controller/processor 340. The control information may be for the PBCH, PCFICH, PHICH, PDCCH, etc. The data may be for the PDSCH, etc. Processor 320 may process (e.g., encode and symbol map) the data and control information to obtain data symbols and control symbols, respectively. Processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At UE 120, antennas 352a through 352r may receive the downlink signals from base station 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for UE 120 to a data sink 360, and provide decoded control information to a controller/processor 380.

On the uplink, at UE 120, a transmit processor 364 may receive and process data (e.g., for the PUSCH) from a data source 362 and control information (e.g., for the PUCCH) from controller/processor 380. Processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to base station 110. At base station 110, the uplink signals from UE 120 may be received by antennas 334, processed by demodulators 332, detected by a MIMO detector 336 if applicable, and further processed by a receive processor 338 to obtain decoded data and control information sent by UE 120. Processor 338 may provide the decoded data to a data sink 339 and the decoded control information to controller/processor 340.

Controllers/processors 340 and 380 may direct the operation at base station 110 and UE 120, respectively. Controller/processor 340, receive processor 338, and/or other processors and modules at base station 110 may perform or direct processes for the techniques described herein. Memories 342 and 382 may store data and program codes for base station 110 and UE 120, respectively. A scheduler 344 may schedule UEs for data transmission on the downlink and/or uplink.

### Example Resource Partitioning

According to certain aspects of the present disclosure, when a network supports enhanced interference coordination, the base stations may negotiate with each other to coordinate resources in order to reduce or eliminate interference by the interfering cell's giving up part of its resources. In accordance with this interference coordination, a UE may be able to access a serving cell even with severe interference by using resources yielded by the interfering cell.

For example, a femto cell with a closed access mode (i.e., in which only a member femto UE can access the cell) in the coverage area of an open macro cell may be able to create a “coverage hole” for a macro cell by yielding resources and effectively removing interference. By negotiating for a femto cell to yield resources, the macro UE under the femto cell coverage area may still be able to access its serving macro cell using these yielded resources.

In a radio access system using OFDM, such as E-UTRAN, the yielded resources may be time based, frequency based or a combination of both. When the coordinated resource partitioning is time based, the interfering cell may simply not use some of the subframes in the time domain. When the coordinated resource partitioning is frequency based, the interfering cell may yield subcarriers in the frequency domain. With a combination of both frequency and time, the interfering cell may yield frequency and time resources.

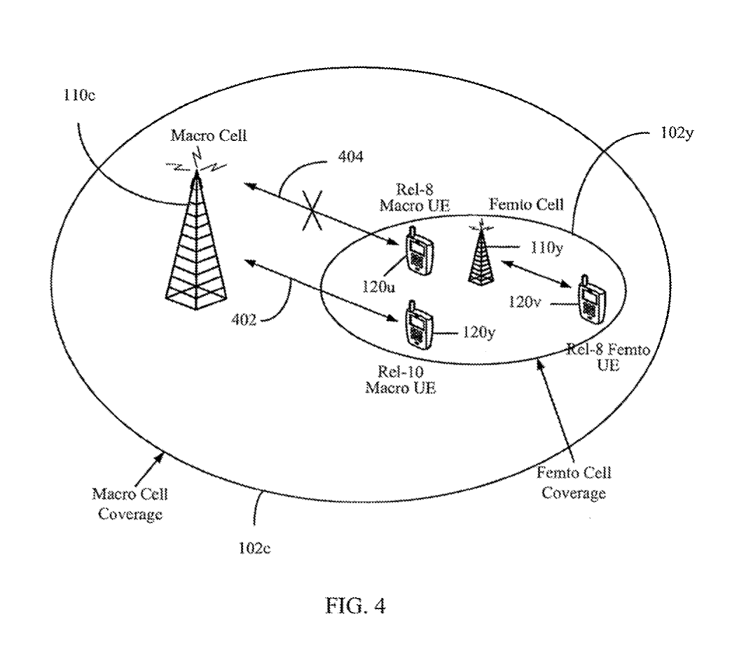

FIG. 4 shows an example scenario where enhanced inter-cell interference coordination (eICIC) can allow a macro UE supporting eICIC (Rel-10 Macro UE in the figure) to access the macro cell even when it is under severe interference from the femto cell.

According to certain aspects, networks may support enhanced interference coordination, where there may be different sets of partitioning information. A first of these may be referred to as Semi-static Resource Partitioning information (SRPI). A second of these sets may be referred to as Adaptive Resource Partitioning information (ARPI). As the name implies, SRPI typically does not change frequently, and it may be sent to the UE so that the UE can use the resource partitioning information for its own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For the downlink (e.g., from a cell node B to a UE), a partitioning pattern may be mapped to a known subframe (e.g., a first subframe of each radio frame that has SFN value that is a multiple of an integer N). Such a mapping may be applied in order to determine resource-partitioning information for a specific subframe. As an example, a subframe that is subject to coordinated resource partitioning (e.g., yielded by an interfering cell) for the downlink may be identified by an index:

Index_{SRPI}_{_{—}}_{DL}=(SFN*10+subframe number)mod 8

For the uplink, the SRPI mapping may be shifted, for example, by 4 ms. Thus, an example for the uplink may be:

Index_{SRPI}_{_{—}}_{UL}=(SFN*10+subframe number+4)mod 8

SRPI may use the following three values for each entry:
U (Use): this value indicates the subframe has been cleaned up from the dominant interference to be used by this cell (i.e., the main interfering cells do not use this subframe).
N (No Use): this value indicates the subframe shall not be used.
X (Unknown): This value indicates the subframe is not statically partitioned. Details of resource usage negotiation between base stations are not known to the UE.

Another possible set of parameters for SRPI can be the following:
U (Use): this value indicates the subframe has been cleaned up from the dominant interference to be used by this cell. I.e. the main interfering cells do not use this subframe.
N (No Use): this value indicates the subframe shall not be used.
X (Unknown): This value indicates the subframe is not statically partitioned. Details of resource usage negotiation between base stations are not known to the UE.
C (Common): this value may indicate all cells may use this subframe without resource partitioning. This subframe may be subject to interference, so that the base station may choose to use it only for the UE that is not under big interference.

The serving cell's SRPI may be broadcasted over the air. In E-UTRAN, the SRPI of the serving cell may be sent in an MIB, or one of the SIBs. A predefined SRPI may be defined based on the characteristics of cells, e.g. macro cell, pico cell (with open access) and femto cell (with close access). In such a case, encoding of SRPI in the system overhead message may result in more efficient broadcast over the air.

The base station may also broadcast the neighbor cell's SRPI in one of the SIBs. For this, SRPI may be sent with its corresponding range of physical cell IDs.

ARPI may represent further resource partitioning information with the detailed information for the ‘X’ subframes in SRPI. As noted above, detailed information for the ‘X’ subframes is typically only known to the base stations and UE does not know it.

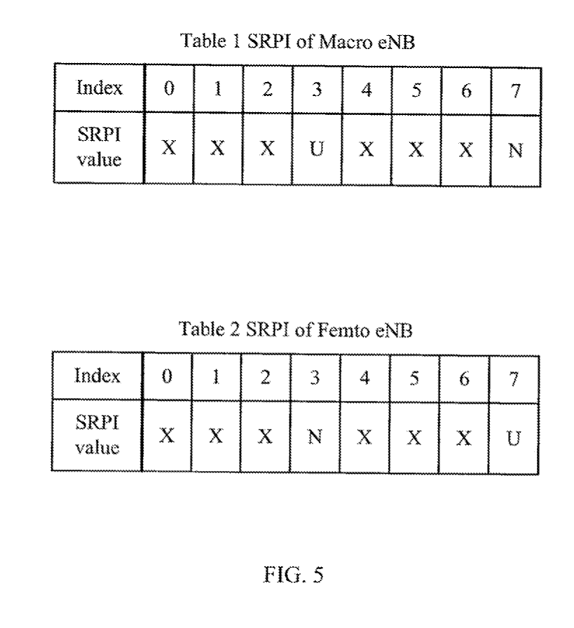

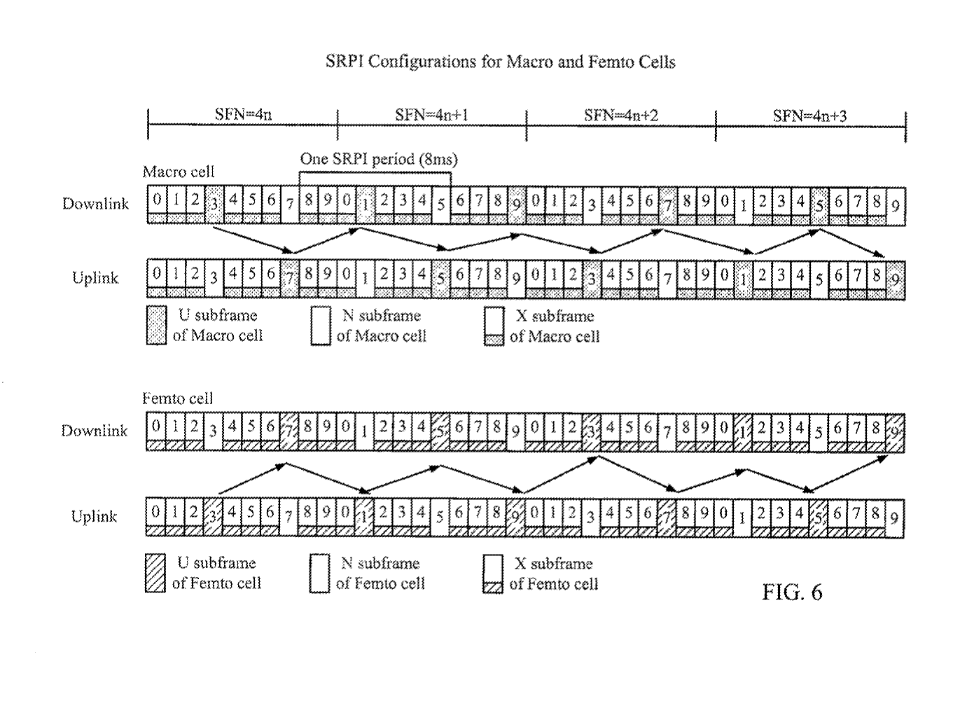

FIGS. 5 and 6 illustrate examples of SRPI assignment in the scenario with macro and femto cells. A U, N, X, or C subframe is a subframe corresponding to a U, N, X, or C SRPI assignment.

### Example Uplink Timing Management and Uplink Power Control

In LTE, eNB generally controls UL transmission timing by issuing timing advance (TA) commands to UEs. TA commands are intended for the eNB to control the UL timings of the UEs in a given cell such that the received UL signals from the UEs are synchronous. In addition, the TA commands may minimize intra-cell interference and ensure orthogonality of some UL signals for proper UL operations. However, it is not necessary and sometimes not possible to ensure the same UL reception timing across different cells. In certain aspects, a UE may derive its UL transmission timing based on the TA commands and received DL timing of the cell.

In Rel-10, a UE may be configured for two or more carriers (Carrier Aggregation, CA), one of which is generally configured as the primary component carrier or PCC (also called primary cell or PCell, where a cell is a combination of a DL CC and a UL CC), and the remaining CCs are secondary CCs (SCCs). The PCC and one or more SCCs together may be referred to as a TA group. Regardless of how many carriers are configured for a UE, the UL timing is generally always based on the DL component of the PCC. As a result, there is typically only one UL timing for the multiple carriers configured for the UE, that is, the UL transmission timing for a UE across different carriers is the same (i.e., one TA group for all the configured CCs).

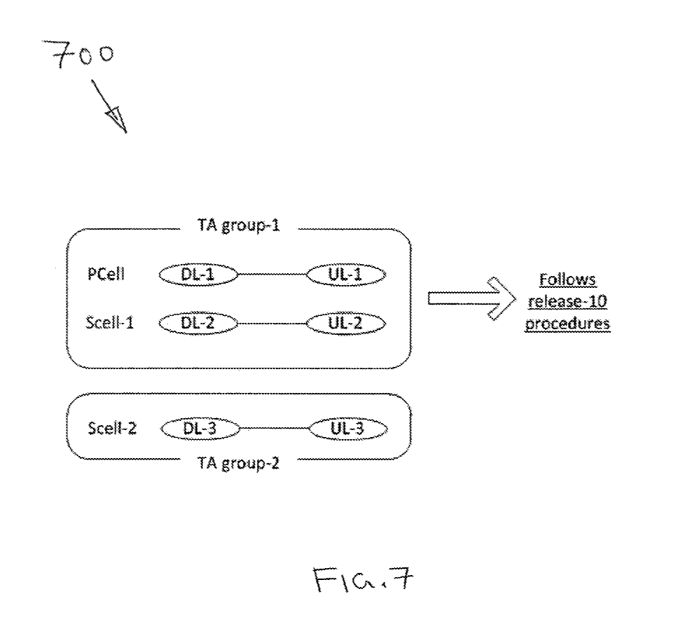

In Rel-11 and beyond, a UE may be configured with at least two TA groups. In this case, the reference DL CC for UL timing within a TA group not containing a PCC may be based on the UL CC on which the Physical Random Access Channel (PRACH) is transmitted. For example, FIG. 7 illustrates UE configuration 700 for two TA groups in accordance with certain aspects of the present disclosure. As shown in FIG. 7, TA group1 includes PCell and Secondary cell (SCell) SCell-1, and TA group-2 includes secondary cell Scell-2 only. Thus, for TA group-1, (following Rel10 procedures) DL reference CC for UL timing is Pcell. For TA group-2, DL reference CC for UL timing may be Scell-2.

In LTE, uplink power control may include open loop power control and closed loop power control. In open loop power control, a UE may be indicated cell-specific and UE-specific open loop power control parameters. Power control may further be based on open loop path loss measurement. In closed loop power control, a UE may be issued transmission power control (TPC) commands via unicast or groupcast controls channels.

In certain aspects, separate power control loops may be maintained for each channel, e.g. Physical uplink shared channel (PUSCH) power control, physical uplink control channel (PUCCH) power control and sounding reference signal (SRS) power control.

For PUSCH power control both accumulative and absolute power control modes may be supported for closed loop. A UE may be configured via higher layers on which mode is to be used. For accumulative power control, accumulated power control commands at a subframe i may be maintained via a power control function f(i)=f(i−1)+δ_{PUSCH}(i−K_{PUSCH}), where δ_{PUSCH} is the received power control commands, and the value K_{PUSCH} defines the timing relationship.

For PUCCH power control, only accumulative power control is typically supported for closed loop. Accumulated power control commands at subframe i may be maintained via a power control function g(i)=g(i−1)+sum_{m=0}̂{M−1} δ_{PUSCH}(i−k_m), where δ_{PUSCH} is the received power control commands, and the value k_m defines the timing relationship. In an aspect, for frequency division duplex (FDD) M=1, and k_{—}0=4. In an aspect, for time division duplex (TDD), values of M and k_m depend on the downlink and uplink subframe configuration.

SRS power control is generally tied with PUSCH via the same function f(i). This may include configurable power offset between SRS and PUSCH and may account for bandwidth difference.

In certain aspects, a UE may report its power headroom under certain conditions to the eNB. Power headroom is the difference between the nominal UE maximum transmit power and an estimated power for PUSCH transmission in a current subframe. This information is reported by UEs to the eNB in configurable Power Headroom Reports (PHR). In an aspect, the power headroom is derived based on the PUSCH transmit power and a maximum transmit power.

In Rel-10, as noted above, a UE may be configured for two or more carriers, one of which may be configured as the primary component carrier or PCC (also called primary cell or PCell, where a cell is a combination of a DL CC and a UL CC). In an aspect, regardless of how many carriers are configured for a UE, PUCCH is typically only transmitted on the PCC. In an aspect, UE may maintain separate accumulative power control loops for PUSCH for different CCs. For example, function f_c(i), where c is the serving cell c part of the CCs. Since there is only one PUCCH for a UE, there may only be one function g(i).

Upon power limitation, the UE may perform power prioritization among the UL channels. For example, PUCCH may be given highest priority followed by PUSCH. The power headroom report (PHR) may be reported for Type 1 with no PUCCH and where PHR is based on PUSCH, and Type 2 with PUCCH and where PHR is based on PUCCH and PUSCH.

In Rel-11, Coordinated multipoint (CoMP) transmission schemes may be supported, which refers to schemes where multiple base stations coordinate transmissions to (DL CoMP) or receptions from (UL CoMP) for one or more UEs. DL CoMP and UL CoMP may be separately or jointly enabled for a UE.

Some examples of CoMP schemes include joint transmission (DL CoMP) where multiple eNBs may transmit the same data meant for a UE, Joint reception (UL CoMP) where multiple eNBs may receive the same data meant for a UE, Coordinated beamforming where an eNB may transmit to its UE using beams that are chosen to reduce interference to UEs in neighboring cells, and Dynamic point(s) selection where the cell(s) involved in data transmissions may change from subframe to subframe.

CoMP may exist in homogeneous networks and/or heterogeneous networks (HetNet). The nodes involved in CoMP may be connected via X2 (some latency, limited bandwidth) or fiber backhaul (min latency and unlimited bandwidth). In HetNet CoMP, low power nodes, sometimes also referred to as remote radio heads (RRHs) are used for range expansion. For example, within a Macro cell coverage, multiple remote radio head (RRH) may be deployed to enhance capacity/coverage of a network.

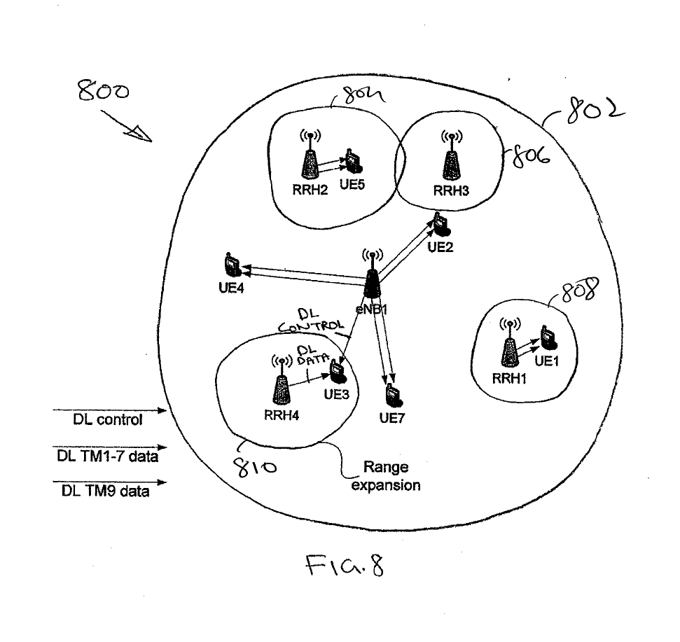

In certain aspects, decoupled control and data transmission is possible in CoMP. FIG. 8 illustrates an example HetNet 800 implementing a CoMP scheme where control and data transmission are decoupled, in accordance with certain aspects of the present disclosure. As shown in FIG. 8, HetNet 800 includes a eNB 1 (e.g., a macro eNB) with coverage region 802. HetNet 800 further includes RRHs 1-4 with respective coverage regions 804-810 that expand the coverage region 802 of eNB 1. UEs 2, 4 and 7 are served by eNB1 and receive DL control and data signals from eNB1. UEs 1 and 5 are served by RRHs 1 and 2 respectively, and receive control and data from their respective RRHs. As shown in FIG. 8, UE3 receives DL control from eNB1 and DL data from RRH4. Thus, DL control and data for UE3 are decoupled. Further, in certain aspects, there maybe a first set DL cells (S_{DL}) and/or a second set of UL cells (S_{UL}) involved in serving a UE where both sets may have one or more cells. For example, the UE may perform wireless communications with UL transmissions sent to a first set of one or more transmission points (TPs) and DL transmissions received from a second set of one or more TPs. In an aspect, the two sets may not necessarily be the same.

In certain aspects, dynamic switching of the set of DL cells and/or the set of UL cells may take place. For example, a network switch may occur to a different set of one or more TPs for at least one of the first or second set of TPs.

Several issues may arise as a result of the switching. For example, with the switching of cells, a need may arise to determine which DL cell and/or CC should be used as a TA reference for UL timing, and how to achieve efficient UL timing management.

In certain aspects, traditional power control relies on one power control function (f(i) or g(i)) on a per carrier basis. Frequent switching between serving cells (e.g. geographically non-collocated cells) may cause inefficiency in UL power control management. For example, an f(i) maintained for cell 1 may not be desirable for cell 2, when the two cells are located differently and/or have different channel characteristics.

In certain aspects, a solution to the UL timing issue may depend on the CoMP schemes, and/or the cells involved in UL reception. In an aspect, the DL reference cell (or DL CC) used as a TA reference may be based on the cell carrying PDCCH, one cell carrying PDSCH, or one cell carrying the PUSCH and the system information block-2 (SIB-2) linked DL cell.

In an aspect, such reference cell after the switch may be explicitly signalled (e.g. by Radio Resource Control (RRC) or a control channel), or implicitly derived (e.g. via a pre-determined scheme based on the configured CoMP scheme). In an aspect, the UE may use more than one cells (or DL CCs) as TA reference after a switch in serving cells, and the one or more DL CCs to be used may be explicitly signalled to the UE or implicitly derived by the UE.

In certain aspects, for the explicit signalling, a 1-bit scrambling identifier (ID) may be reused to indicate the reference signal. In addition, the change of DL reference signal for UL timing may be semi-static or dynamic.

In certain aspects, different CoMP schemes may require different schemes. Moreover, one CoMP scheme may possibly have two or more schemes. In certain aspects, different schemes may exist for different UEs, even if the CoMP schemes are the same for the UEs. The scheme thus may be UE-specific (since the “anchor” UL cell is UE-specific). However, for each cell, the UL reception of all UEs may still be expected to be synchronous.

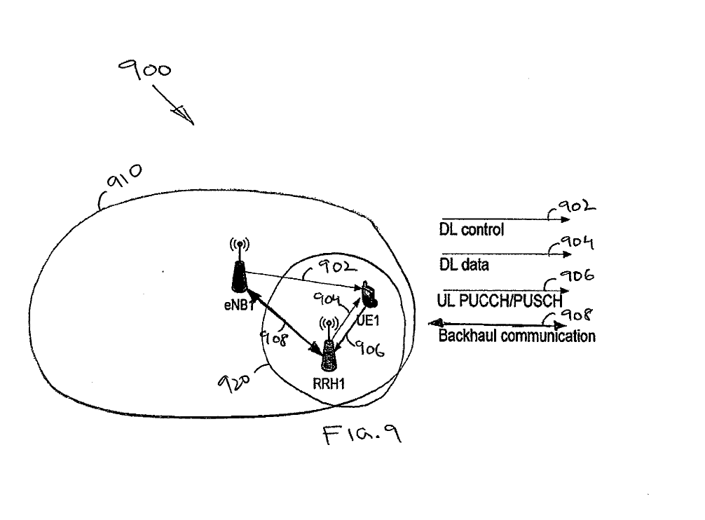

FIG. 9 illustrates an example UL timing determination for a CoMP scheme 900 implemented in a wireless network where control and data transmission may be decoupled in accordance with certain aspects of the present disclosure. The wireless network for FIG. 9 includes eNB 1 (e.g., macro eNB) with coverage region 910 and RRH1 with coverage region 920. In the example CoMP scheme 900, eNB1 is the only cell performing DL control (PDCCH) transmission 902 to UE 1. DL data transmission 904 and UL reception 906 are performed by RRH1. In certain aspects, if eNB1 and RRH1 may communicate using a good backhaul (e.g., backhaul 908) with no delay in communication and no bandwidth limitation, it does not matter which cell is used for DL reference cell (e.g., based on the PDCCH cell or the PDSCH cell), since necessary TA commands may be shared between eNB1 and RRH1 and may adjust accordingly.

However, in cases where the eNB1 and RRH1 are not connected by a good backhaul (e.g., large delay or bandwidth limited) sharing large amounts of timing information may not be possible. Thus, there may be a need for a better procedure to determine UL timing, especially when control and data are decoupled.

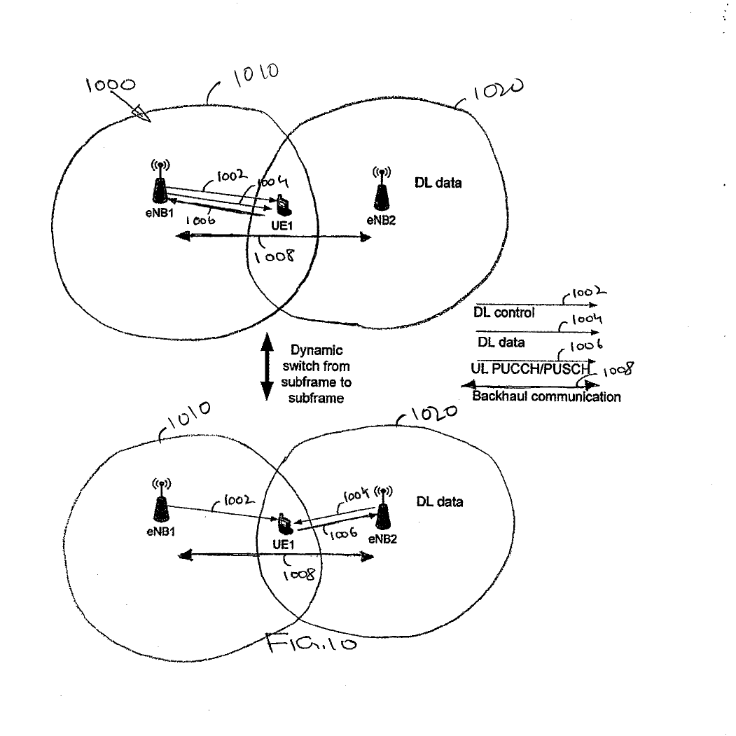

FIG. 10 illustrates an example of UL timing determination for a CoMP scheme 1000 implemented in a wireless network when DL and UL transmissions are switched between cells, in accordance with certain aspects of the present disclosure. The wireless network of FIG. 10 includes eNB 1 with coverage region 1010 and eNB2 with coverage region 1020 overlapping a portion of region 1010. UE1 is positioned in the overlapping coverage region. In this example CoMP scheme 1000, DL control (PDCCH) transmission 1002 is always associated with eNB1. However, DL data (PDSCH) 1004 and UL PUCCH/PUSCH 1006 transmissions dynamically switch between eNB1 and eNB2

In an aspect, one particular cell may be used semi-statically for DL reference if eNB1 and eNB2 are connected by a good backhaul 1008 (e.g. fiber or anything with very low latency) such that the two cells may share TA commands without any meaningful latency. The UE1 may be issued a TA command whenever the PDSCH/PUSCH/PUCCH cell switches, which is additional overhead.

In certain aspects, if eNB1 and eNB2 are not connected by a good backhaul, UE1 may be explicitly indicated which cell to use as DL reference cell, and the DL reference may also dynamically switch along with PDSCH/PUSCH/PUCCH.

For certain aspects, in some cases, it may become necessary to define DL reference cell dependent TA commands and/or UL timing management (e.g., when there is dynamic switching among DL reference cells as discussed earlier).

In certain aspects, assuming dynamic switching between two DL reference cells (e.g., between eNB1 and eNB2), UE1 may maintain two UL timing branches, one each for eNBs 1 and 2. Additionally, the TA commands may be cell dependent with certain commands dedicated to eNB1 and others dedicated to eNB2. In an aspect, the association of TA commands with a particular cell may be explicitly signaled to the UE or implicitly derived by the UE (e.g., associated with PDSCH serving cell).

In certain aspects, when a UE is configured with multiple carriers and at least two TA groups, the above techniques may be applied separately for each TA group. In an aspect, same or different schemes may be implemented for different TA groups for the same UE.

For certain aspects, a UE may be signaled to disable or enable open loop power control for PUSCH and/or PUCCH individually for the nodes involved in CoMP.

In certain aspects, cell-dependent power control accumulative loops may be defined. In an aspect, the cell(s) currently serving the UEs may be explicitly or implicitly indicated to the UE. For example, the 1-bit scrambling ID in Downlink Control Information (DCI) format 2C may be used as an indication if switching is involved with two sets of serving cells. In certain aspects, UEs may maintain power control functions f_s(i) and/or g_s(i), where s is the index of the serving cell(s). In an aspect, enabled UE may enable or disable power control functions based on the one or more serving cells serving the UE.

In certain aspects, separate power headroom reports (PHRs) may be reported accordingly based on the set s. Also, separate (set dependent) power control commands may be transmitted to the UE based on the set s for maintaining the power control functions for the sets.

Further, in certain aspects, cross-cell power control commands may be enabled. For example, a cell set 1 may transmit power control commands for maintaining f(i) or g(i) for a different set 2. The transmissions may be done via a unicast PDCCH or a groupcast PDCCH (e.g., 2/3A, wherein the RNTI, the TPC-index in the DCI formats, or a combination thereof, indicates the intended cell and the UE).

For certain aspects, when the UE is configured for carrier aggregation (CA), the UE may maintain power control functions f_{c,s}(i) and/or g_{c,s}(i), where c is the index of the carrier and s is the index of the serving cell(s) corresponding to carrier c. By doing so, efficient UL power control may be achieved. In an aspect, f_s(i) (or g_s(i)) may be associated with each serving cell(s), and upon cell switching, the corresponding f_s(i) (or g_s(i)) may be used without the need of re-adapting the accumulative loops for the new serving cell(s).

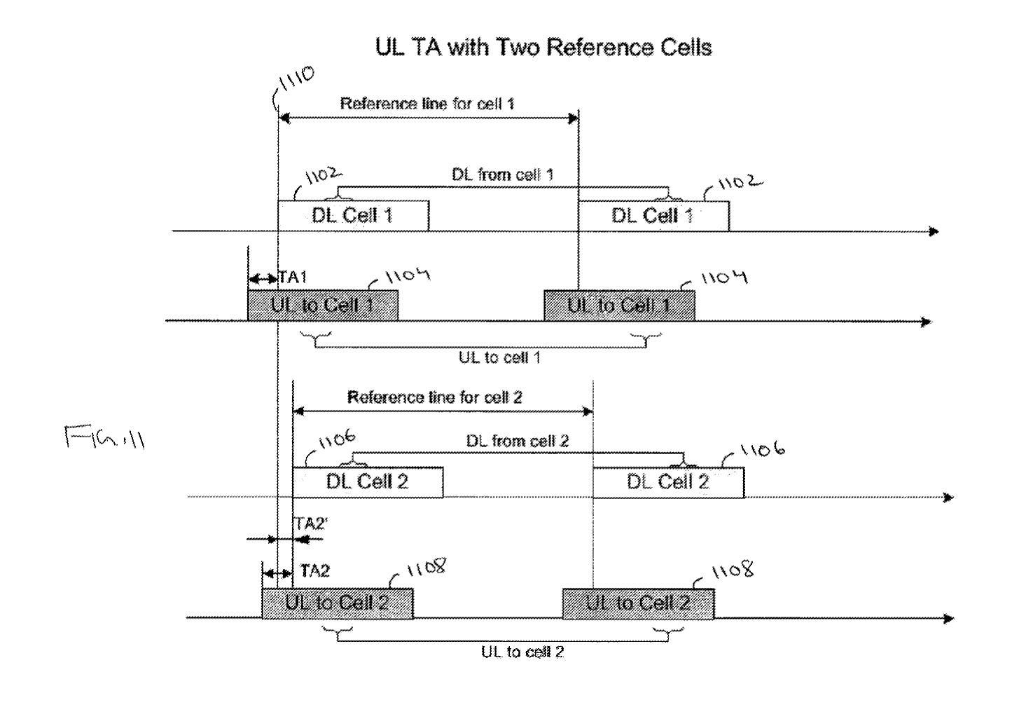

FIG. 11 illustrates example timing advance (TA) signaling for uplink transmissions for two reference cells in accordance with certain aspects of the present disclosure. 1102 represents downlink transmission from cell 1, 1104 represents uplink transmissions received at cell 1, 1106 represents downlink transmissions from cell 2 and 1108 represents uplink transmissions received at cell 2.

In certain aspects, the UL TA may always be with respect to the received downlink signal. For example, TA for cells 1 and 2 may be TA1 and TA2, respectively. In certain aspects, TA for the two cells may use a common reference line (e.g. reference line 1110 for DL of cell1. In this case, TA may always be issued with respect to the common reference line 1110. For example, TA for cells 1 and 2 may be sent as TA1 and TA2′. In an aspect, the TA definition must be known from both eNB and UE sides to correctly apply and maintain UL synchronization.

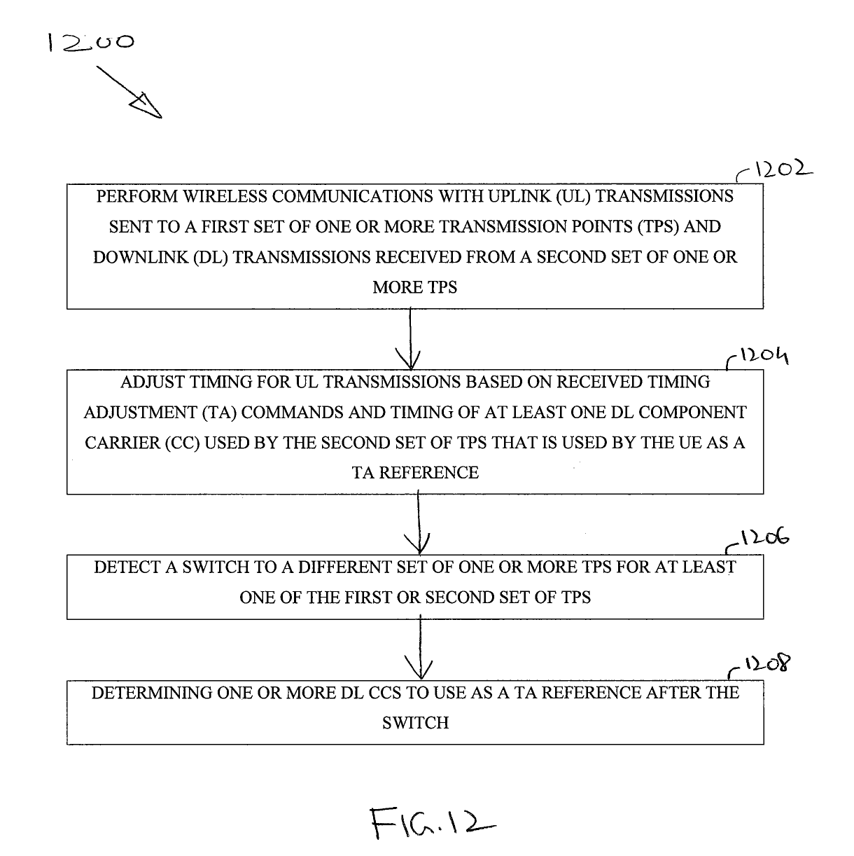

FIG. 12 illustrates example operations 1200 that may be performed by a UE for adjusting timing of uplink transmissions in accordance with certain aspects of the present disclosure. Operations 1200 may begin, at 1202, by performing wireless communications with uplink (UL) transmissions sent to a first set of one or more transmission points (TPs) and downlink (DL) transmissions received from a second set of one or more TPs. At 1204, the UE may adjust timing of UL transmission based on received timing adjustment (TA) commands and timing of at least one DL component carrier (CC) used by the second set of TPs that is used by the UE as a TA reference. At 1206, the UE may detect a switch to a different set of one or more TPs for at least one of the first or second set of TPs. Finally, at 1208, the UE may determine one or more DLCCs to use as a TA reference after the switch.

In an aspect, the detecting the switch may include detecting a cell identifier associated with at least one TP of the different set of the one or more TPs in a downlink transmission. In an aspect, operations 1200 may further include receiving TA commands corresponding to the determined TA reference after the switch, and adjusting timing for UL transmissions based on the received TA commands and timing of the determined one or more DL CCs after the switch. In an aspect, operations 1200 may further include receiving an indication to use the one or more DL CCs as the TA reference after the switch. In an aspect, the determination may be based, at least in part, on a coordinated multipoint (CoMP) scheme used to coordinate uplink transmissions to and/or downlink transmission from the transmission points. In an aspect, the determination may be based, at least in part, on which TPs are in the first set of TPs after the switch. In an aspect, the determination may be based on explicit signaling from a TP. In an aspect, the explicit signaling may include a scrambling identifier (ID) of a reference cell transmitting a determined DL CC. In an aspect, the determination may include determining to use a same DL CC as a reference after the switch as before the switch.

In certain aspects, multiple DL CCs are used as a reference for adjusting timing. The UE receives TP-dependent TA commands and adjusts timing based on a TP-dependent TA command corresponding to one of the multiple DL CCs. Operations 1200 may further include receiving an association of a TP-dependent TA command with a corresponding DL CC. Alternatively, Operations 1200 may include deriving an association of a TP-dependent TA command with a corresponding DL CC based a serving cell from which DL transmission is received.

In an aspect, the determination may be based on a DL CC carrying a physical downlink control channel (PDCCH). In an aspect, the determination may be based on a DL CC carrying a physical uplink shared channel (PUSCH) and system information block (SIB).

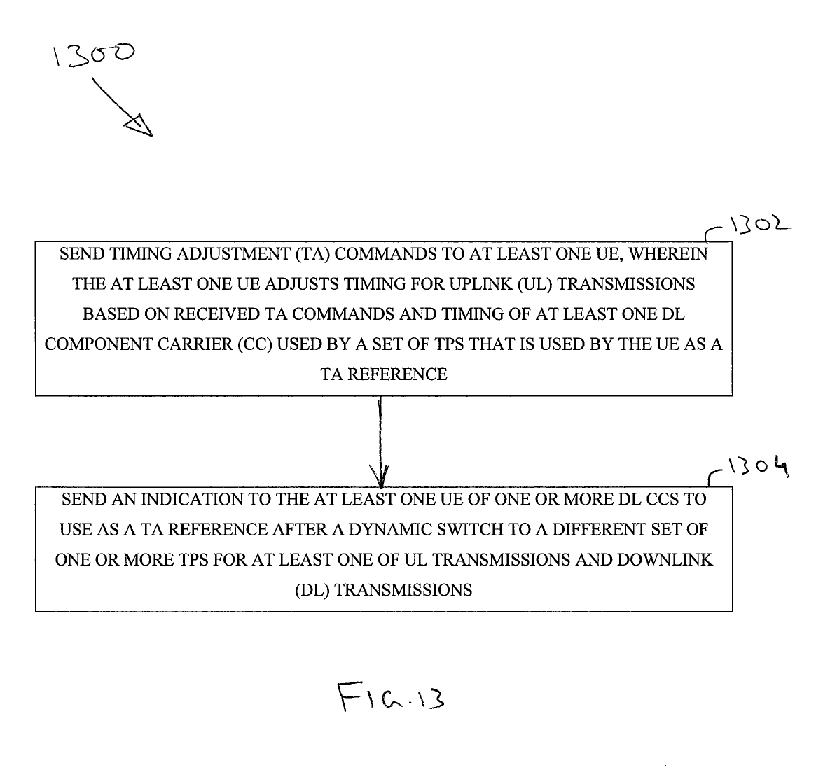

FIG. 13 illustrates example operations 1300 that may be performed by a base station for adjusting timing of uplink transmissions in accordance with certain aspects of the present disclosure. Operations 1300 may begin, at 1302, by sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference. At 1304, the base station may send an indication to the at least one UE of one or more DL CCs to use as a TA reference after a dynamic switch to a different set of one or more TPs for at least one of UL transmissions and downlink (DL) transmissions.

In an aspect, operations 1300 may further include transmitting TA commands corresponding to the determined TA reference after the switch, wherein the at least one UE adjusts timing for UL transmissions based on the received TA commands and timing of the one or more DL CCs after the switch. In an aspect, multiple DL CCs may be used as a reference for adjusting timing. In an aspect, operations 1300 may further include transmitting an association of a TP-dependent TA command with a corresponding DL CC. In an aspect, the indication comprises a scrambling an identifier (ID) of a reference cell transmitting a DL CC after the switch. In an aspect, operations 1300 may further include negotiating TA commands with at least one other base station after the switch, wherein the indication comprises a negotiated TA command after the switch.

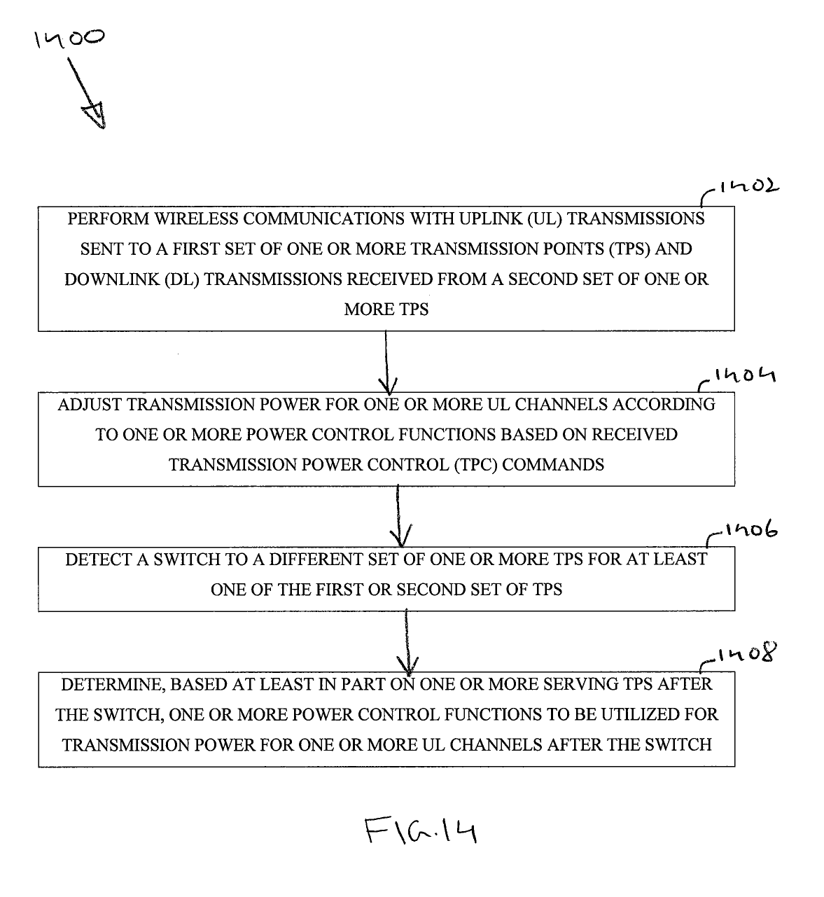

FIG. 14 illustrates example operations 1400 that may be performed by a UE for adjusting power of uplink transmissions in accordance with certain aspects of the present disclosure. Operations 1400 may being, at 1402, by performing wireless communications with uplink (UL) transmissions sent to a first set of one or more transmission points (TPs) and downlink (DL) transmissions received from a second set of one or more TPs. At 1404, the UE may adjust transmission power for one or more UL channels according to one or more power control functions based on received transmission power control (TPC) commands. At 1406, the UE may detect a switch to a different set of one or more TPs for at least one of the first or second set of TPs. At 1408, the UE may determine, based at least in part on a serving TP after the switch, one or more power control functions to be utilized for transmission power for one or more UL channels after the switch.

In an aspect, each power control function corresponds to a UL channel. In an aspect, the UE maintains at least one power control function for each serving TP. In an aspect, wherein the determined one or more power control functions comprise power control functions maintained for the one or more TPs after the switch. In an aspect, the UE can enable or disable a power control function corresponding to a UL channel for particular a serving cell. In an aspect, the detecting the switch comprises detecting a cell identifier associated with at least one TP of the different set of the one or more TPs in a downlink transmission. In an aspect the one or more power control functions may include at least a first power control function used to adjust transmission power of a physical uplink shared channel (PUSCH), and at least a second power control function used to adjust transmission power of a physical uplink control channel (PUCCH).

In an aspect, the different set of one or more TPs is explicitly signaled to the UE, wherein the explicit signaling may include a scrambling identifier (ID) indicating the one or more serving TPs after the switch. In an aspect the UE maintains at least one power control function for each component carrier (CC) of a TP. In an aspect, the one or more power control functions are determined further based on one or more CCs corresponding to each serving TP after the switch. In an aspect, the determined one or more power control functions comprise one or more power control functions maintained for the one or more CCs.

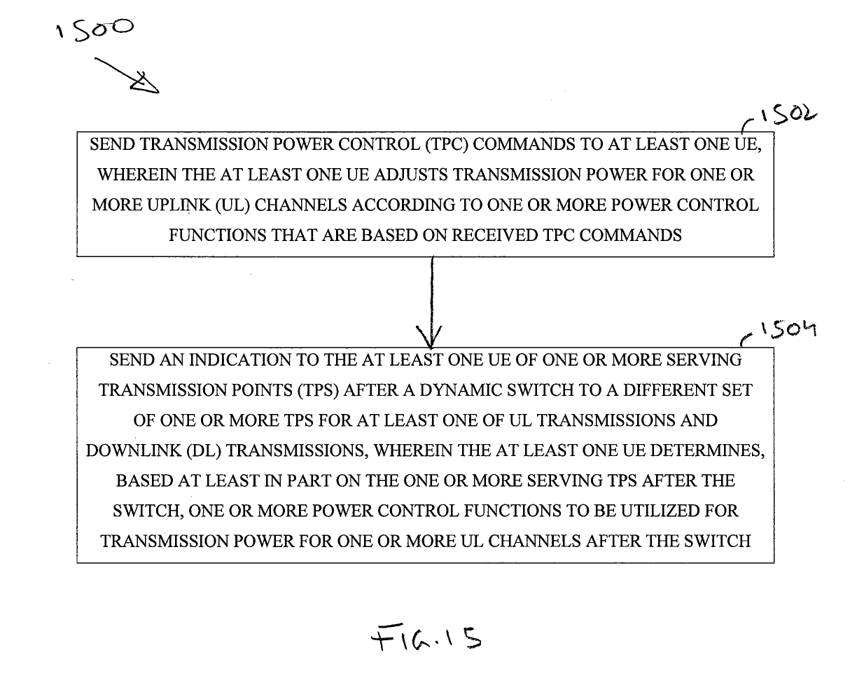

FIG. 15 illustrates example operations 1500 that may be performed by a base station for adjusting power of uplink transmissions in accordance with certain aspects of the present disclosure. Operations 1500 may begin, at 1502, by sending transmission power control (TPC) commands to at least one UE, wherein the at least one UE adjusts transmission power for one or more uplink (UL) channels according to one or more power control functions that are based on received TPC commands. At 1504, the base station may send an indication to the at least one UE of one or more serving transmission points (TPs) after a dynamic switch to a different set of one or more TPs for at least one of UL transmissions and downlink (DL) transmissions, wherein the at least one UE determines, based at least in part on the one or more serving TPs after the switch, one or more power control functions to be utilized for transmission power for one or more UL channels after the switch.

In an aspect, each power control function corresponds to a UL channel. In an aspect, the one or more power control functions include at least a first power control function used to adjust transmission power of a physical uplink shared channel (PUSCH), and at least a second power control function used to adjust transmission power of a physical uplink control channel (PUCCH). In an aspect, operations 1500 may further include explicitly signaling the different set of one or more TPs to the at least one UE. In an aspect, the explicit signaling comprises a scrambling identifier (ID) indicating the one or more serving TPs after the switch.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for adjusting timing of uplink transmissions by a UE, comprising:
performing wireless communications with uplink (UL) transmissions sent to a first set of one or more transmission points (TPs) and downlink (DL) transmissions received from a second set of one or more TPs;
adjusting timing for UL transmissions based on received timing adjustment (TA) commands and timing of at least one DL component carrier (CC) used by the second set of TPs that is used by the UE as a TA reference;
detecting a switch to a different set of one or more TPs for at least one of the first or second set of TPs; and
determining one or more DL CCs to use as a TA reference after the switch.

2. The method of claim 1, wherein detecting the switch comprises detecting a cell identifier associated with at least one TP of the different set of the one or more TPs in a downlink transmission.

3. The method of claim 1, further comprising:
receiving TA commands corresponding to the determined TA reference after the switch; and
adjusting timing for UL transmissions based on the received TA commands and timing of the determined one or more DL CCs after the switch.

4. The method of claim 1, further comprising:
receiving an indication to use the one or more DL CCs as the TA reference after the switch.

5. The method of claim 1, wherein the determination is based, at least in part, on a coordinated multipoint (CoMP) scheme used to coordinate uplink transmissions to and/or downlink transmission from the transmission points.

6. The method of claim 1, wherein the determination is based, at least in part, on which TPs are in the first set of TPs after the switch.

7. The method of claim 1, wherein the determination is based on explicit signaling from a TP.

8. The method of claim 7, wherein the explicit signaling comprises a scrambling identifier (ID) of a reference cell transmitting a determined DL CC.

9. The method of claim 1, wherein:
the determination comprises determining to use a same DL CC as a reference after the switch as before the switch.

10. The method of claim 1, wherein:
multiple DL CCs are used as a reference for adjusting timing;
the UE receives TP-dependent TA commands; and
the UE adjusts timing based on a TP-dependent TA command corresponding to one of the multiple DL CCs.

11. The method of claim 10, further comprising:
receiving an association of a TP-dependent TA command with a corresponding DL CC.

12. The method of claim 10, further comprising:
deriving an association of a TP-dependent TA command with a corresponding DL CC based a serving cell from which DL transmission is received.

13. The method of claim 1, wherein the determination is based on a DL CC carrying a physical downlink control channel (PDCCH).

14. The method of claim 1, wherein the determination is based on a DL CC carrying a physical downlink shared channel (PDSCH).

15. The method of claim 1, wherein the determination is based on a DL CC carrying a physical uplink shared channel (PUSCH) and system information block (SIB).

16. A method for adjusting timing of uplink transmissions by a base station, comprising:
sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference; and
sending an indication to the at least one UE of one or more DL CCs to use as a TA reference after a dynamic switch to a different set of one or more TPs for at least one of UL transmissions and downlink (DL) transmissions.

17. The method of claim 16, further comprising:
transmitting TA commands corresponding to the determined TA reference after the switch, wherein the at least one UE adjusts timing for UL transmissions based on the received TA commands and timing of the one or more DL CCs after the switch.

18. The method of claim 16, wherein multiple DL CCs are used as a reference for adjusting timing.

19. The method of claim 18, further comprising:
transmitting TP-dependent TA commands, wherein the UE adjusts timing based on a TP-dependent TA command corresponding to one of the multiple CCs.

20. The method of claim 19, further comprising:
transmitting an association of a TP-dependent TA command with a corresponding DL CC.

21. The method of claim 16, wherein the indication comprises a scrambling an identifier (ID) of a reference cell transmitting a DL CC after the switch.

22. The method of claim 16, further comprising:
negotiating TA commands with at least one other base station after the switch,
wherein the indication comprises a negotiated TA command after the switch.

23. A method for adjusting power of uplink transmissions by a UE, comprising:
performing wireless communications with uplink (UL) transmissions sent to a first set of one or more transmission points (TPs) and downlink (DL) transmissions received from a second set of one or more TPs;
adjusting transmission power for one or more UL channels according to one or more power control functions based on received transmission power control (TPC) commands;
detecting a switch to a different set of one or more TPs for at least one of the first or second set of TPs; and
determining, based at least in part on one or more serving TPs after the switch, one or more power control functions to be utilized for transmission power for one or more UL channels after the switch.

24. The method of claim 23, wherein each power control function corresponds to a UL channel.

25. The method of claim 23, wherein the UE maintains at least one power control function for each serving TP.

26. The method of claim 25, wherein the determined one or more power control functions comprise power control functions maintained for the one or more TPs after the switch.

27. The method of claim 23, wherein the UE can enable or disable a power control function corresponding to a UL channel for particular a serving cell.

28. The method of claim 23, wherein detecting the switch comprises detecting a cell identifier associated with at least one TP of the different set of the one or more TPs in a downlink transmission.

29. The method of claim 23, wherein the one or more power control functions comprise:
at least a first power control function used to adjust transmission power of a physical uplink shared channel (PUSCH); and
at least a second power control function used to adjust transmission power of a physical uplink control channel (PUCCH).

30. The method of claim 23, wherein the different set of one or more TPs is explicitly signaled to the UE.

31. The method of claim 30, wherein the explicit signaling comprises a scrambling identifier (ID) indicating the one or more serving TPs after the switch.

32. The method of claim 23, wherein:
the UE maintains at least one power control function for each component carrier (CC) of a TP.

33. The method of claim 32, wherein the one or more power control functions are determined further based on one or more CCs corresponding to each serving TP after the switch.

34. The method of claim 33, wherein the determined one or more power control functions comprise one or more power control functions maintained for the one or more CCs.

35. A method for adjusting power of uplink transmissions by a base station, comprising:
sending transmission power control (TPC) commands to at least one UE, wherein the at least one UE adjusts transmission power for one or more uplink (UL) channels according to one or more power control functions that are based on received TPC commands; and
sending an indication to the at least one UE of one or more serving transmission points (TPs) after a dynamic switch to a different set of one or more TPs for at least one of UL transmissions and downlink (DL) transmissions,
wherein the at least one UE determines, based at least in part on the one or more serving TPs after the switch, one or more power control functions to be utilized for transmission power for one or more UL channels after the switch.

36. The method of claim 35, wherein each power control function corresponds to a UL channel.

37. The method of claim 35, wherein the one or more power control functions comprise:
at least a first power control function used to adjust transmission power of a physical uplink shared channel (PUSCH); and
at least a second power control function used to adjust transmission power of a physical uplink control channel (PUCCH).

38. The method of claim 35, further comprising:
explicitly signaling the different set of one or more TPs to the at least one UE.

39. The method of claim 38, wherein the explicit signaling comprises a scrambling identifier (ID) indicating the one or more serving TPs after the switch.

40. An apparatus for adjusting timing of uplink transmissions by a UE, comprising:
means for performing wireless communications with uplink (UL) transmissions sent to a first set of one or more transmission points (TPs) and downlink (DL) transmissions received from a second set of one or more TPs;
means for adjusting timing for UL transmissions based on received timing adjustment (TA) commands and timing of at least one DL component carrier (CC) used by the second set of TPs that is used by the UE as a TA reference;
means for detecting a switch to a different set of one or more TPs for at least one of the first or second set of TPs; and
means for determining one or more DL CCs to use as a TA reference after the switch.

41. The apparatus of claim 40, wherein the means for detecting the switch is further configured to detect a cell identifier associated with at least one TP of the different set of the one or more TPs in a downlink transmission.

42. The apparatus of claim 40, further comprising:
means for receiving TA commands corresponding to the determined TA reference after the switch; and
means for adjusting timing for UL transmissions based on the received TA commands and timing of the determined one or more DL CCs after the switch.

43. The apparatus of claim 40, further comprising:
means for receiving an indication to use the one or more DL CCs as the TA reference after the switch.

44. The apparatus of claim 40, wherein the determination is based on explicit signaling from a TP.

45. The apparatus of claim 40, wherein:
multiple DL CCs are used as a reference for adjusting timing;
the UE receives TP-dependent TA commands; and
the UE adjusts timing based on a TP-dependent TA command corresponding to one of the multiple DL CCs.

46. The apparatus of claim 45, further comprising:
means for receiving an association of a TP-dependent TA command with a corresponding DL CC.

47. The apparatus of claim 45, further comprising:
means for deriving an association of a TP-dependent TA command with a corresponding DL CC based a serving cell from which DL transmission is received.

48. An apparatus for adjusting timing of uplink transmissions by a UE, comprising:
at least one processor configured to:
perform wireless communications with uplink (UL) transmissions sent to a first set of one or more transmission points (TPs) and downlink (DL) transmissions received from a second set of one or more TPs;
adjust timing for UL transmissions based on received timing adjustment (TA) commands and timing of at least one DL component carrier (CC) used by the second set of TPs that is used by the UE as a TA reference;
detect a switch to a different set of one or more TPs for at least one of the first or second set of TPs; and
determine one or more DL CCs to use as a TA reference after the switch; and
a memory coupled to the at least one processor.

49. A computer program product for adjusting timing of uplink transmissions by a UE, comprising:
a computer-readable medium comprising instructions for:
performing wireless communications with uplink (UL) transmissions sent to a first set of one or more transmission points (TPs) and downlink (DL) transmissions received from a second set of one or more TPs;
adjusting timing for UL transmissions based on received timing adjustment (TA) commands and timing of at least one DL component carrier (CC) used by the second set of TPs that is used by the UE as a TA reference;
detecting a switch to a different set of one or more TPs for at least one of the first or second set of TPs; and
determining one or more DL CCs to use as a TA reference after the switch.

50. An apparatus for adjusting timing of uplink transmissions by a base station, comprising:
means for sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference; and
means for sending an indication to the at least one UE of one or more DL CCs to use as a TA reference after a dynamic switch to a different set of one or more TPs for at least one of UL transmissions and downlink (DL) transmissions.

51. The apparatus of claim 50, further comprising:
means for transmitting TA commands corresponding to the determined TA reference after the switch, wherein the at least one UE adjusts timing for UL transmissions based on the received TA commands and timing of the one or more DL CCs after the switch.

52. The apparatus of claim 50, wherein multiple DL CCs are used as a reference for adjusting timing.

53. The apparatus of claim 52, further comprising:
means for transmitting TP-dependent TA commands, wherein the UE adjusts timing based on a TP-dependent TA command corresponding to one of the multiple CCs.

54. The apparatus of claim 53, further comprising:
means for transmitting an association of a TP-dependent TA command with a corresponding DL CC.

55. The apparatus of claim 50, wherein the indication comprises a scrambling an identifier (ID) of a reference cell transmitting a DL CC after the switch.

56. An apparatus for adjusting timing of uplink transmissions by a base station, comprising:
at least one processor configured to:
send timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference; and
send an indication to the at least one UE of one or more DL CCs to use as a TA reference after a dynamic switch to a different set of one or more TPs for at least one of UL transmissions and downlink (DL) transmissions; and
a memory coupled to the at least one processor.

57. A computer program product for adjusting timing of uplink transmissions by a base station, comprising:
a computer-readable medium comprising code for:
sending timing adjustment (TA) commands to at least one UE, wherein the at least one UE adjusts timing for uplink (UL) transmissions based on received TA commands and timing of at least one DL component carrier (CC) used by a set of TPs that is used by the UE as a TA reference; and
sending an indication to the at least one UE of one or more DL CCs to use as a TA reference after a dynamic switch to a different set of one or more TPs for at least one of UL transmissions and downlink (DL) transmissions.

58. An apparatus for adjusting power of uplink transmissions by a UE, comprising:
means for performing wireless communications with uplink (UL) transmissions sent to a first set of one or more transmission points (TPs) and downlink (DL) transmissions received from a second set of one or more TPs;
means for adjusting transmission power for one or more UL channels according to one or more power control functions based on received transmission power control (TPC) commands;
means for detecting a switch to a different set of one or more TPs for at least one of the first or second set of TPs; and
means for determining, based at least in part on one or more serving TPs after the switch, one or more power control functions to be utilized for transmission power for one or more UL channels after the switch.

59. The apparatus of claim 58, wherein the UE maintains at least one power control function for each serving TP.

60. The apparatus of claim 59, wherein the determined one or more power control functions comprise power control functions maintained for the one or more TPs after the switch.

61. The apparatus of claim 58, wherein the means for detecting the switch is further configured to detect a cell identifier associated with at least one TP of the different set of the one or more TPs in a downlink transmission.

62. The apparatus of claim 58, wherein:
the UE maintains at least one power control function for each component carrier (CC) of a TP.

63. The apparatus of claim 62, wherein the one or more power control functions are determined further based on one or more CCs corresponding to each serving TP after the switch.

64. The apparatus of claim 63, wherein the determined one or more power control functions comprise one or more power control functions maintained for the one or more CCs.

65. An apparatus for adjusting power of uplink transmissions by a UE, comprising:
at least one processor configured to:
perform wireless communications with uplink (UL) transmissions sent to a first set of one or more transmission points (TPs) and downlink (DL) transmissions received from a second set of one or more TPs;
adjust transmission power for one or more UL channels according to one or more power control functions based on received transmission power control (TPC) commands;
detect a switch to a different set of one or more TPs for at least one of the first or second set of TPs; and
determine, based at least in part on one or more serving TPs after the switch, one or more power control functions to be utilized for transmission power for one or more UL channels after the switch; and
a memory coupled to the at least one processor.

66. A computer program product for adjusting power of uplink transmissions by a UE, comprising:
a computer-readable medium comprising instruction for:
performing wireless communications with uplink (UL) transmissions sent to a first set of one or more transmission points (TPs) and downlink (DL) transmissions received from a second set of one or more TPs;
adjusting transmission power for one or more UL channels according to one or more power control functions based on received transmission power control (TPC) commands;
detecting a switch to a different set of one or more TPs for at least one of the first or second set of TPs; and
determining, based at least in part on one or more serving TPs after the switch, one or more power control functions to be utilized for transmission power for one or more UL channels after the switch.

67. An apparatus for adjusting power of uplink transmissions by a base station, comprising:
means for sending transmission power control (TPC) commands to at least one UE, wherein the at least one UE adjusts transmission power for one or more uplink (UL) channels according to one or more power control functions that are based on received TPC commands; and
means for sending an indication to the at least one UE of one or more serving transmission points (TPs) after a dynamic switch to a different set of one or more TPs for at least one of UL transmissions and downlink (DL) transmissions,
wherein the at least one UE determines, based at least in part on the one or more serving TPs after the switch, one or more power control functions to be utilized for transmission power for one or more UL channels after the switch.

68. The apparatus of claim 67, wherein each power control function corresponds to a UL channel.

69. The apparatus of claim 67, wherein the one or more power control functions comprise:
at least a first power control function used to adjust transmission power of a physical uplink shared channel (PUSCH); and
at least a second power control function used to adjust transmission power of a physical uplink control channel (PUCCH).

70. The apparatus of claim 67, further comprising:
means for explicitly signaling the different set of one or more TPs to the at least one UE.

71. The apparatus of claim 70, wherein the explicit signaling comprises a scrambling identifier (ID) indicating the one or more serving TPs after the switch.

72. An apparatus for adjusting power of uplink transmissions by a base station, comprising:
at least one processor configured to:
send transmission power control (TPC) commands to at least one UE, wherein the at least one UE adjusts transmission power for one or more uplink (UL) channels according to one or more power control functions that are based on received TPC commands; and
send an indication to the at least one UE of one or more serving transmission points (TPs) after a dynamic switch to a different set of one or more TPs for at least one of UL transmissions and downlink (DL) transmissions,
wherein the at least one UE determines, based at least in part on the one or more serving TPs after the switch, one or more power control functions to be utilized for transmission power for one or more UL channels after the switch; and
a memory coupled to the at least one processor.

73. A computer program product for adjusting power of uplink transmissions by a base station, comprising:
a computer-readable medium comprising instructions for:
sending transmission power control (TPC) commands to at least one UE, wherein the at least one UE adjusts transmission power for one or more uplink (UL) channels according to one or more power control functions that are based on received TPC commands; and
sending an indication to the at least one UE of one or more serving transmission points (TPs) after a dynamic switch to a different set of one or more TPs for at least one of UL transmissions and downlink (DL) transmissions,
wherein the at least one UE determines, based at least in part on the one or more serving TPs after the switch, one or more power control functions to be utilized for transmission power for one or more UL channels after the switch.
